(19) United States
(12) Patent Application Publication
(10) Pub. No.: US 2025/0305831 A1
(43) Pub. Date: Oct. 2, 2025

(54) SYSTEM AND A METHOD FOR FLIGHT ROUTE RECOMMENDATION

(71) Applicant: Airable Aviation Inc., Richmond (CA)

(72) Inventor: Saeed Golzar, North Vancouver (CA)

(21) Appl. No.: 19/081,078

(22) Filed: Mar. 17, 2025

Related U.S. Application Data
(60) Provisional application No. 63/572,079, filed on Mar. 29, 2024.

(51) Int. Cl. G01C 21/20; G06Q 50/40

(52) U.S. Cl. CPC G01C 21/20; G06Q 50/40

(57) ABSTRACT

Embodiments of the present disclosure relate to a system and device for recommending one or more flight routes in response to a user query received from a user device. The system constructs a plurality of route profiles for a plurality of routes amongst a plurality of aerodromes. The system further receives at least one aircraft profile from an operator. The system analyzes the plurality of route profiles, the at least one aircraft profile and the user query and accordingly provides one or more recommended flight routes to the user device.

### TECHNICAL FIELD

The disclosure generally relates to the creation of routes that aircraft may fly as a route. More particularly, the disclosure relates to systems, devices, articles, and methods for the construction of routes, pricing of flights on the routes, and recommending flights based on user queries and input from aircraft operators.

### BACKGROUND

The purpose of the following description of related art is solely to provide background information pertaining to the relevant field of the disclosure. It should be noted that this section is only to enhance the understanding of the reader with respect to the present disclosure. Therefore, unless otherwise indicated, it should not be assumed that any of the information described in this section qualifies as prior art merely by virtue of their inclusion in this section.

Recently, private commercial aviation including private jets and helicopters has seen a significant enhancement in market presence. The demand for such private commercial aviation is expected to continue growing due to its unique benefits over standard or traditional commercial flights. Private commercial aviation provides unparalleled scheduling flexibility and customised plans, allowing a user to choose his airports and flight times. Private aircraft are also faster than commercial flights, thereby reducing travel time. Such advantages particularly appeal to business travellers and individuals seeking convenience, efficiency, and exclusivity in their travel experience. However, private commercial aviation has various disadvantages such as higher costs compared to traditional commercial airlines and exhibiting distinct operational practices in management and use of its aircraft.

### SUMMARY

This section is intended to introduce certain objectives and aspects of the present disclosure in a simplified manner. The disclosure relates to a method of operation in a system including at least one processor, and a user device in communication with the at least one processor. The method includes constructing, by the at least one processor, a plurality of route profiles for a plurality of routes amongst a plurality of aerodromes, wherein the plurality of aerodromes comprises a plurality of departure locations, and a plurality of arrival locations; receiving, at the at least one processor, from at least one operator, at least one aircraft profile comprising a hub aerodrome and an operational envelope for at least one aircraft; receiving, at the at least one processor from the user device, a user query comprising a plurality of user transportation parameters; analysing, by the at least one processor, the plurality of route profiles, the at least one aircraft profile and the user query; and providing, by the at least one processor to the user device, the one or more recommended flight routes based on analysis of the plurality of route profiles, the at least one aircraft profile and the user query.

In one embodiment, the method includes receiving, by the at least one processor, a change in the plurality of user transportation parameters; and providing at least one alternative flight route to the user device based on the change in the plurality of user transportation parameters.

In another embodiment, the method includes checking if flights corresponding to the one or more recommended flight routes are temporally compliant with respect to, at least one of, duty cycle, visual flight rules and operator on-time performance. The method also includes presenting the one or more recommended flight routes to the user device in form of a table or a map. The method also includes constructing a plurality of route profiles for a plurality of routes amongst the plurality of aerodromes for the at least one aircraft profile comprising the hub aerodrome, wherein the plurality of route profiles is selected from one of a hub and spoke model and a complete graph.

Further, the embodiments of the present disclosure encompass a system comprising a processor-based user device, at least one processor communicatively coupled to the user device, and at least one non-transitory processor-readable storage device communicatively coupled to the at least one processor and which stores processor-executable instructions which, when executed by the at least one processor, cause the at least one processor to: receive a plurality of route profiles for a plurality of routes amongst a plurality of aerodromes, wherein the plurality of aerodromes includes a plurality of departure locations and a plurality of arrival locations; receive at least one aircraft profile from at least one operator comprising a hub aerodrome and an operational envelope for the at least one aircraft; receive a user query from the user device, wherein the user query comprises a plurality of user transportation parameters; analyse the plurality of route profiles, the at least one aircraft profile and the user query; and provide, to the user device, the one or more recommended flight routes based on analysis of the plurality of route profiles, the at least one aircraft profile and the user query.

In another embodiment, the at least one processor receive a change in the plurality of user transportation parameters; and provide, by the at least one processor to the user device, at least one alternative flight route based on the change in the plurality of user transportation parameters.

In another embodiment, the at least one processor checks if flights corresponding to the one or more recommended flight routes are temporally compliant with respect to at least one of duty cycle, visual flight rules, and operator on-time performance. In another embodiment, the at least one processor presents the one or more recommended flight routes to the user device in the form of a table or a map. In yet another embodiment, the at least one processor constructs a plurality of route profiles for the plurality of routes amongst the plurality of aerodromes for the at least one aircraft profile comprising the hub aerodrome, wherein the plurality of route profiles is selected from a hub and spoke model and a complete graph.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Systems, devices, and methods are described in greater detail herein with reference to the following figures in which:

FIG. 1 illustrates a general overview of the system architecture, wherein the system includes a plurality of circuits.

FIG. 2 illustrates an overview of user device architecture connected to various components working together

FIG. 3 illustrates a schematic view of a plurality of aerodromes and at least one route between the plurality of aerodromes.

FIG. 4 illustrates an implementation of a method of operation of the plurality of circuits or user device.

FIG. 5 illustrates an implementation of a method of operation of the plurality of circuits or user device.

FIG. 6 illustrates a schematic view of a route including a departure aerodrome and a destination aerodrome in accordance with an embodiment of the invention.

The above-mentioned drawings illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. Also, the embodiments shown in the figures are not to be construed as limiting the invention but only as illustrative examples of an automated method and system according to the invention that are illustrated herein to highlight the advantages of the invention.

### DETAILED DESCRIPTION

In the following description, associated drawings, included claims, and other parts of the document, various details are set forth to provide a detailed understanding of the disclosure and embodiments thereof. It will be apparent, however, that the disclosed embodiments may be practiced without these details. Several features described hereafter can each be used independently of one another or with any combination of other features.

Hence, in view of the above-mentioned problems and challenges, the Applicant appreciates there is a need for an efficient system and method for building flight routes and accordingly recommending flight routes used based on user queries.

Embodiments of the present disclosure relate to a system and a method for recommending one or more flight routes based on a user query comprising a plurality of transportation parameters. A plurality of route profiles is constructed for a plurality of routes amongst a plurality of aerodromes while at least one aircraft profile is received from at least one operator. Said plurality of route profiles, the at least one aircraft profile, and the user query are collectively analyzed to provide the one or more recommended flight routes. Additionally, at least one alternative flight route is provided to the user device based on a change in the plurality of user transportation parameters. The system and method also include checking if flights corresponding to the one or more recommended flight routes are temporally compliant with respect to at least one of duty cycle, visual flight rules, and operator on-time performance. The system and method also provides option to update the user query. Moreover, the system may be adapted to operate completely or in parts at a user device level, a server level, or a combination thereof.

The term “a” or “an” when used in conjunction with the terms “comprise”, “include”, “comprising”, or “including” in the claims or the specification may mean “one”, “one or more”, “at least one”, and “a plurality” unless the content dictates otherwise. Similarly, the word “another” means “additional” or “at least a second” unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two units or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, “input”, “send”, “transfer”, “transmit”, “receive”, “output” and their cognate terms refer to sending and/or receiving information from one unit to another unit of the system, wherein said information refer to all the data mentioned in the disclosure and may or may not be modified before or after sending and receiving the information according to the desired requirements.

As used herein, the term “alternative” refers to other possibilities available in case of changes in user input/query in accordance with the invention. The terms ‘alternative’ and ‘alternate’ may be interchangeably used throughout the specification.

The I/O device(s) as used herein includes one or more user interface input devices, such as a display, a keyboard, a mouse, a microphone, and a camera. The one or more user interface input devices may be detachable. In some embodiments, the I/O device(s) includes one or more output devices, such as displays, speakers, and lights. In some embodiments, the I/O device(s) is a single light. The one or more I/O devices may be detachable. The I/O device(s) may include one or more sensors (such as altimeters, transducers, thermometers, force sensors, strain gauge, clock) and output devices (such as actuators, displays, lights).

The processor may be any logic processing unit such as one or more microprocessors, central processing units (CPUs), digital signal processors (DSPs), graphics processing units (GPUs), application-specific integrated circuits (ASICs), programmable gate arrays (PGAs), programmed logic units (PLUS) or any such device as may be obvious to a person skilled in the art. The processor may include, but is not limited to, a processor or set of processors or any such processing unit as may be obvious to a person skilled in the art, that are configured to function in accordance with the invention. The terms ‘processor’ and ‘processing unit’ may be interchangeably used throughout the specification.

The circuits as used herein refers to any components, units, hardware element or any such unit as may be obvious to a person skilled in the art.

The Applicant appreciates to overcome the problems inherent in the existing solutions, there exists a need for an efficient system and method for managing and scheduling private commercial aviation. In particular, there is a need for efficiently building flight routes and subsequently recommending flights used based on user-specific query.

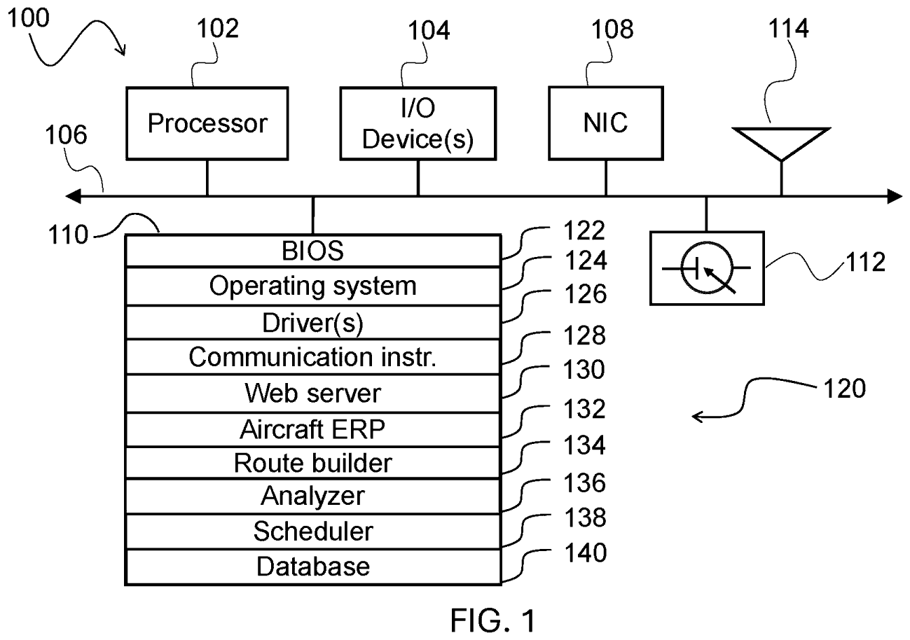

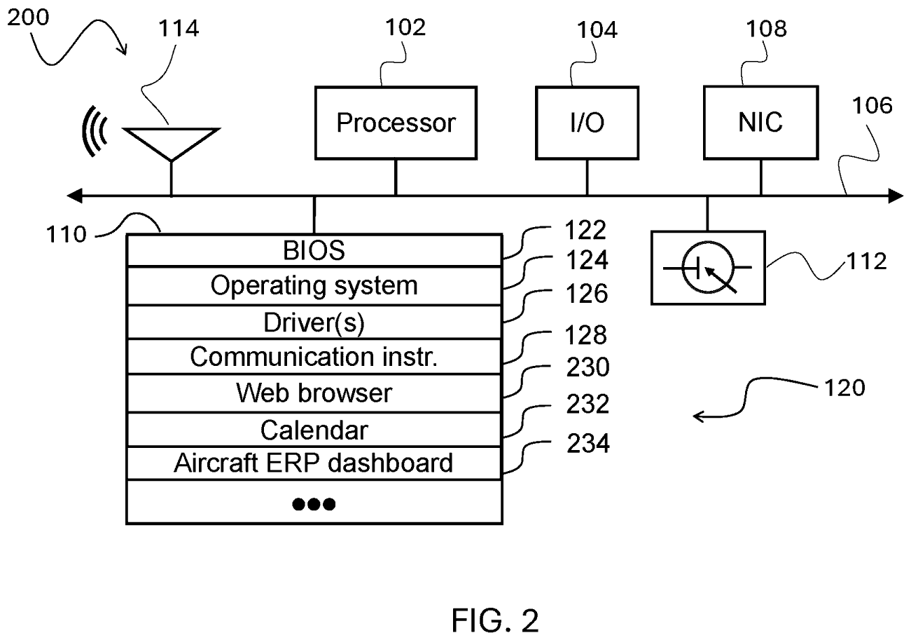

FIG. 1 illustrates a schematic view of aspects of a plurality of circuits 100 in accordance with some embodiments of the invention. The plurality of circuits 100 includes a control subsystem comprising at least one processor 102, at least one input/output (I/O) subsystem 104, and at least one bus 106 to which, or by which, the at least one processor 102 and the I/O device(s) 104 are communicatively coupled. A user device 200 is communicatively coupled to plurality of circuits 100 and is further describe in relation to, at least, FIG. 2.

Further, the plurality of circuits 100 includes a Network Interface Card (NIC) or network interface subsystem 108 communicatively coupled to bus(es) 106, wherein network interface subsystem 108 provides bi-directional communication to other components (e.g. a system external to plurality of circuits 100) through one or more network or non-network communication channel(s) such as internet. In some embodiments, network interface subsystem 108 includes a circuitry. In another embodiments, network interface subsystem 108 uses communication protocols (e.g. FTP, HTTP, Web Services, and SOAP with XML) for bidirectional communication of information including processor-readable data, and processor-executable instructions.

Furthermore, the plurality of circuits 100 includes at least one non-transitory computer or processor-readable storage device(s) 110 coupled to the bus(es) 106. The terms ‘non-transitory computer’ and ‘processor-readable’ may be interchangeably used throughout the specification. Further, said storage device(s) 110 includes at least one non-transitory storage medium. In one embodiment, the storage device(s) 110 includes two or more distinct devices, while in another embodiment, the storage device(s) 110 includes one or more volatile storage devices (e.g. Random Access Memory (RAM)), and one or more non-volatile storage devices (e.g. Read Only Memory (ROM), flash memory, magnetic hard disk (HDD), optical disk, solid state disk (SSD), and the like). In an embodiment, the storage device(s) 110 may be implemented in a variety of ways such as a read-only memory (ROM), random access memory (RAM), a hard disk drive (HDD), a network drive, flash memory, digital versatile disk (DVD) or any such forms as may be obvious to a person skilled in the art. Further, modern computer systems and techniques conflate volatile storage and non-volatile storage, for example, caching, using solid-state devices as hard drives, in-memory data processing, and the like.

The storage device(s) 110 may store on or within the included storage media processor-readable data and/or processor-executable instructions. Storage device(s) 110 include or store processor-executable instructions and/or processor-readable data 120 associated with the operation of plurality of circuits 100, a plurality of aircraft, and the like in accordance with the present invention. The terms ‘processor-executable instructions’ and ‘processor-readable data’ may be interchangeably used throughout the specification.

In some embodiments, the processor-executable instructions/data 120 include a Basic Input/Output System (BIOS) 122, an operating system 124, driver(s) 126, communication instructions/data 128, a web server 130, an aircraft ERP 132, a route builder 134, an analyzer 136, a scheduler 138, database 140, and the like.

In an exemplary scenario, the operating system 124 is ANDROID®, LINUX®, WINDOWS® and the like. The driver(s) 126 include processor-executable instructions/data that allows the at least one processor 102 to control one or more components in the plurality of circuits 100. The processor-executable communication instructions/data 128 implements communications between the plurality of circuits 100 and another processor-based device through network interface subsystem 108 in accordance with the invention.

The plurality of circuits 100 further includes one or more power supplies 112. In one embodiment, the power supply(ies) 112 are external power supply(ies), while in another embodiment, the power supply(ies) 112 are on-board power source(s) such as batteries, ultra-capacitors, or fuel cells, to independently power different components in accordance with the present invention.

Also, the plurality of circuits 100 includes at least one antenna 114. In response to processor-executable instructions, the antenna (e) 114 emits electronic signals and receive electronic signals in accordance with the present invention.

The processor-executable communication instructions/data 120, when executed, directs the plurality of circuits 100 to process input from I/O device(s) 104, antenna€ 114, or sensors included in a wider system, information that represents input stored on or in a storage device, e.g., storage device(s) 110. In some embodiments, the processor-executable input instructions 120, when executed, direct the plurality of circuits 100 to communicate with each other in accordance with the invention.

The user device 200 transmits a user query to the at least one processor 102, wherein the user query comprises a plurality of user transportation parameters such as at least one of time, a first location, a second location, a departure time, an arrival time, cost, number of passengers or any such parameter as may be obvious to a person skilled in the art. In an embodiment, the plurality of user transportation parameters includes time inferred from a location associated with the user device 200. In some embodiments, the processor-executable input instructions 120, when executed, directs the plurality of circuits 100 to provide an option to the user device 200 to update the user query. In an embodiment, the user device can be of a traveller or passenger. In another embodiment, the user device can be of a non-traveller (for example-operator, aircraft crew or any such person excluding traveller as may be obvious to a person skilled in the art. Thus, the option to change the user query is provided to a traveller or a non-traveller as mentioned above.

In some embodiments, the web server 130, includes processor-executable instructions or data, which when executed, direct the plurality of circuits 100 to deliver content to devices (e.g., user devices) across a network (e.g., Internet). In some embodiments, the web server 130 includes a plurality of hosted files and instructions, which when executed, provides access to the hosted files. In some embodiments, the web server 130 includes an HTTP server that processes URLs (addresses) and HTTP (the protocol your browser uses to view webpages). For example, if the user query received from the user device 200 includes a URL, the web server 130 finds a requested document, processes it as needed, and sends the document back to the user device by HTTP, wherein said document includes information associated with building routes or presenting routes to a user. For example, the document includes s table or a map containing a plurality of routes.

In some embodiments, the aircraft Enterprise Resource Planning (ERP) 132, includes processor-executable input instructions or data which, when executed, directs the plurality of circuits 100 to write, update, or provide information about operational details of one or more aircraft. The aircraft ERP 132 integrates and automates various systems of record. In one embodiment, the aircraft ERP 132 includes processor-executable instructions or data, which when executed, updates and/or provides information characterizing aircraft Maintenance, Repairs, and Operations (MRO) information. In another embodiment, the aircraft ERP 132 includes instructions to provide real-time or near real-time data on one or more aircraft. For example, location information, instrument data, and other data to monitor aircraft health, usage, and compliance. In a preferred embodiment, the aircraft ERP 132 includes a plurality of aircraft profiles, wherein the at least one aircraft profile comprises a hub aerodrome and an operational envelope for the at least one aircraft In an embodiment, a respective aircraft profile in the aircraft profile includes at least one of climb rate, decent rate, cruise speed, operational envelope, flight rules, fuel capacity or any such parameter as may be obvious to a person skilled in the art. Aircraft ERP 132 may store and retrieve records from database 140.

The processor-executable route builder 134, when executed, directs the plurality of circuits 100 to construct a plurality of route profiles for the plurality of routes amongst the plurality of aerodromes, wherein the plurality of aerodromes includes a plurality of departure locations, a plurality of arrival locations. The plurality of route profiles is information stored on or in storage device(s) 110. The route builder 134, defined in processor-executable instructions 120 which, when executed, plans or optimizes the plurality of route profiles. In some embodiments, a respective profile in the plurality of route profiles includes at least one of altitude, distance, elevation, flight level or any such parameter as may be obvious to a person skilled in the art. In some embodiments, the respective profile in the plurality of route profiles includes at least one of start location and end location.

In another embodiment, the processor-executable route builder 134, when executed, directs the plurality of circuits 100 to construct a plurality of route profiles for the plurality of routes amongst the plurality of aerodromes for the at least one aircraft profile comprising the hub aerodrome, wherein the plurality of route profiles is selected from a hub and spoke graph and a complete graph.

The analyzer 136, includes processor-executable instructions which, when executed, directs the plurality of circuits 100 to process input from the web server 130 that represents a travel request (e.g., the user query). Said analyzer 136, in response to being executed, directs the plurality of circuits 100 to analyze the plurality of route profiles, at least one aircraft profile and the user request, and accordingly provide one or more recommended flight routes. In some embodiments, the one or more recommended flight routes include a time, a departure location, a destination location, and an operator. Further, in an embodiment, the one or more recommended flight routes are presented to the user device 200 in form of a table or a map or any such form as may be obvious to a person skilled in the art. While in another embodiment, the one or more recommended flight routes is provided to the user device 200 in a ranking order based on at least one of the cost, route length, duration, departure time, arrival time or such parameter as may be obvious to a person skilled in the art.

In some embodiments, the analyzer 136, provides at least one alternative flight route based on a change in the plurality of user transportation parameters.

In another embodiment, the analyzer 136 checks if flights corresponding to the one or more recommended flight routes are temporally compliant with respect to at least one of duty cycle, visual flight rules, and operator on-time performance.

In some embodiments, the route builder 134 and the analyzer 136 are combined in to one set of processor-executable instructions and processor-readable data in accordance with the present disclosure.

The processor-executable instructions 120 includes the scheduler 138, which when executed, directs the plurality of circuits 100 to process input from the user device 200, the route profiles and the at least one aircraft profile operator to book or schedule a flight on a route amongst the plurality of routes. In an embodiment, the flight is selected from the one or more recommended flight routes. In some embodiments, scheduler 138 queries database 140.

Turning to FIG. 2 which illustrates a schematic view of aspects of user device 200 in accordance with some embodiments of the invention. The user device 200 includes parts in common with plurality of circuits 100. For example, both include a control subsystem comprising at least one processor 102, at least one input/output (I/O) subsystem 104, and at least one bus 106 to which the foregoing are coupled.

User device 200 includes at least one non-transitory computer or processor-readable storage device(s) 110 coupled to the bus(es) 106. Storage device(s) 110 include, but not limited to, a web browser 230, a calendar 232 and an aircraft ERP dashboard 234.

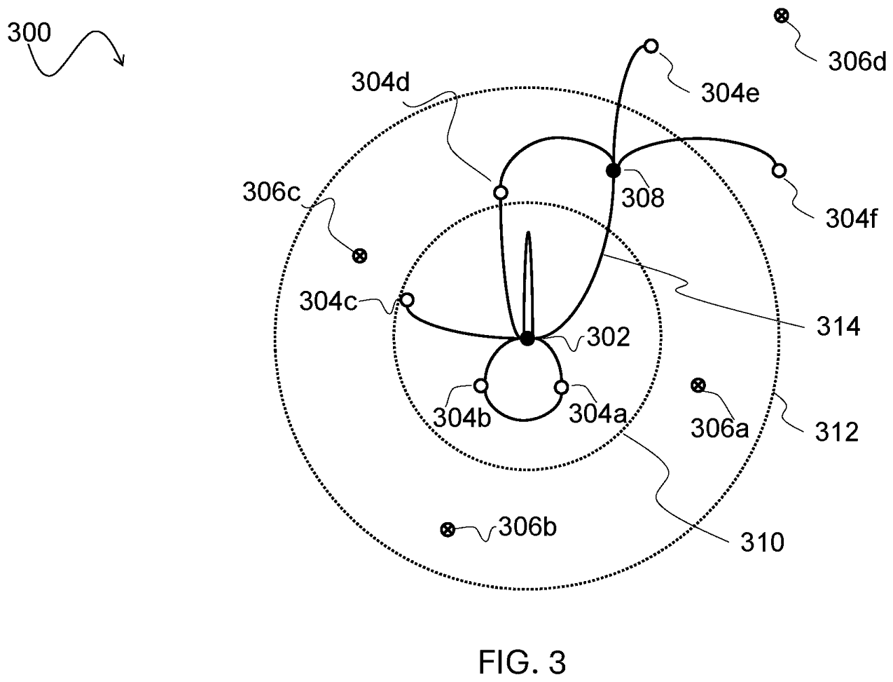

FIG. 3 illustrates schematic view of a plurality of aerodromes 300 including a departure, origin, or hub aerodrome 302 along with an associate route amongst the plurality of aerodromes 300. The schematic view aims to explain the actions of the route builder 134. An aircraft operator based at said aerodrome 302 can fly a plurality of routes to other aerodromes in the plurality of aerodromes 300 and/or the aerodrome 302. Some aerodromes (304a, 304b and 304c) are accessible, wherein said one or more accessible aerodromes (304a, 304b and 304c) include the hub aerodrome 302, e.g., for sightseeing flights. Some aerodromes (306a, 306b and 306c) are inaccessible to the aircraft operator. A first limit 310 is a maximum range for an aircraft or crew to fly or operate based on multiple factors such as fuel range or duty time allowance defined by aircraft specification or operator policy.

In some embodiments, the aerodrome 302 is a hub in a hub-and-spoke model, wherein the hub aerodrome 302 is referred as a hub and the one or more accessible aerodromes (304a, 304b and 304c) are spokes. In some embodiments, the route builder 134 accepts the hub aerodrome 302 to determine the one or accessible aerodromes (304a, 304b and 304c).

In some embodiments, the plurality of aerodromes 300 includes one or more accessible aerodromes beyond first limit 310. For example, aerodromes 308 and 304d exist between the first limit 310 and a second limit 312. In some embodiments, the second limit 312 is a maximum range for an aircraft crew as defined by regulation or operator policy. For example, the aerodrome 308 has the required fuel for the aircraft based at the hub aerodrome 302. As such, as shown, aerodrome 304d and aerodrome 304e are accessible. You could imagine moving first limit 310 from a location centred on hub aerodrome 302 to the aerodrome 308. Similarly, there exists another route 314 between the hub aerodrome 302 and the aerodrome 308. Aerodrome 304e is outside the second limit 312.

Further, as shown in FIG. 3, shape of the routes (i.e., arcs) between aerodromes in the plurality of aerodromes 300 are figurative. These routes can be linear, e.g., polylines. Also, said routes are shown as undirected, however in some embodiments, the routes are directed.

In some embodiments, the route builder 134 accepts the hub aerodrome 302 and determines the one or accessible aerodromes (308, 304a through 304e). In some embodiments, the route builder 134 determines the routes in the hub-and-spoke model, wherein the hub aerodrome 302 is referred as a hub and the one or more accessible aerodromes are spokes. In some embodiments, the route builder 134 determines the routes in a complete graph. For example, receiving the hub aerodrome 302, determining the one or more spokes, and determining the routes between spokes. For example, a route comprising hub aerodrome 302, aerodrome 308, aerodrome 304e, and hub aerodrome 302.

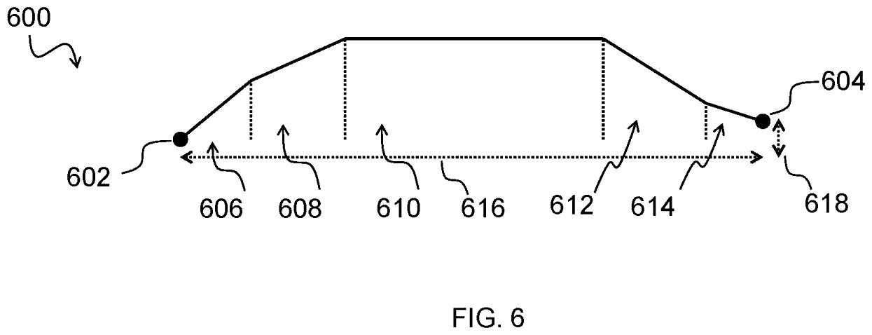

Further, FIG. 6 illustrates schematic view of a route 600 including a departure aerodrome 602, and a destination aerodrome 604. The schematic view provides a third dimension and a fourth dimension that helps explain the actions of the route builder 134. An aircraft on route 600 progresses through a plurality of phases starting from take-off at the departure aerodrome 602. The phases include acceleration 606 and climb 608 to the top of climb. The phases further include cruise phase 610 between the top of the climb and top of decent. Descent 612 is followed by accelerated decent 614, and arrival at the destination aerodrome 604. In some embodiments, the route builder 134 accepts average cruise speed and rates of climb and descent to compute the feasibility of flying or cost of the flying route 600. Route 600 includes attributes such as distance 616, and, optionally, elevation change 618.

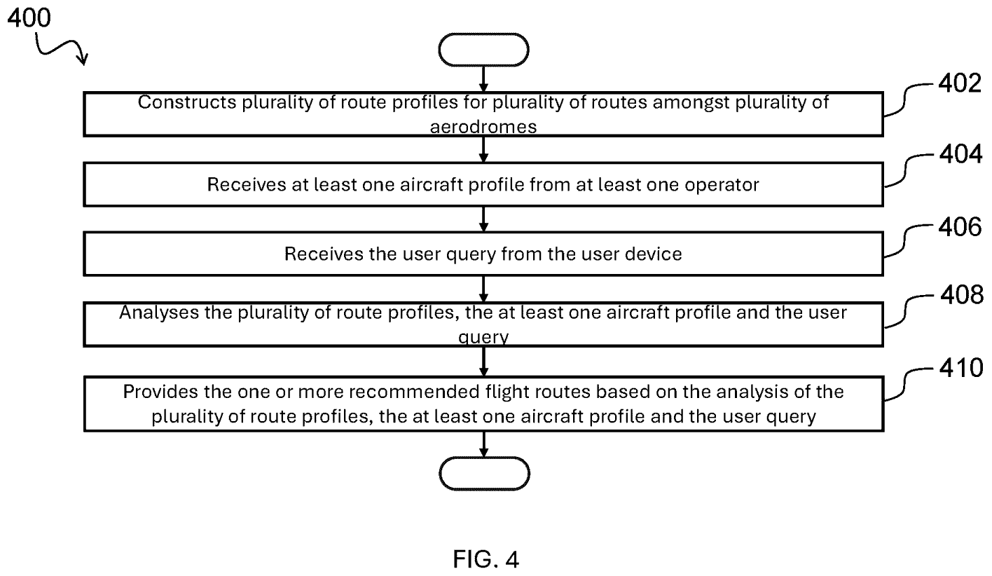

FIG. 4 illustrates an exemplary method 400 for use with the plurality of circuits such as plurality of circuits 100 and the plurality of routes. Various embodiments of plurality of circuits 100 and plurality of routes are described herein including in relation to FIG. 1 through FIG. 3. In particular, FIG. 4 shows method 400 that is executable by a controller, such as circuitry or at least one hardware processor, for the operation, or improvement in the operation, of a plurality of aircraft.

A person skilled in the art will appreciate that other acts may be included, removed, and/or varied or performed in a different order to accommodate alternative implementations. The method 400 may be implemented at the bus(es) 106 through the one or more network or non-network communication channel(s) such as internet. The method 400 may be performed by the at least one processor 102 in conjunction with other components or systems as may be obvious to a person skilled in the art. In an embodiment, the at least one processor 102 may represent the route builder 134, the analyser 136, the web server 130 or any such described unit/component in the disclosure. In another embodiment, the at least one processor 102 may refer to a controller, for example, a controller subsystem, a hardware processor. The method 400 includes details for flight route recommendation, wherein the method 400 initiates at 402.

At 402, the at least one processor constructs the plurality of route profiles for the plurality of routes amongst the plurality of aerodromes.

At 404, the at least one processor receives the at least one aircraft profile from the at least one operator, wherein the at least one aircraft profile comprises hub aerodrome and an operational envelope for the at least one aircraft and any such parameter as may be obvious to a person skilled in the art.

At 406, the at least one processor receives the user query from the user device 200, wherein the user query comprises the plurality of user transportation parameters such as at least one of the first location, the second location, the departure time, the arrival time, the cost, the number of passengers or such parameter as may be obvious to a person skilled in the art.

At 408, the at least one processor analyses the plurality of route profiles, the at least one aircraft profile and the user query.

At 410, the at least one processor provides the one or more recommended flight routes based on the analysis performed at 408. In another embodiment, the one or more recommended flight routes are provided in a form of the table, the map or any such form as may be obvious to a person skilled in the art.

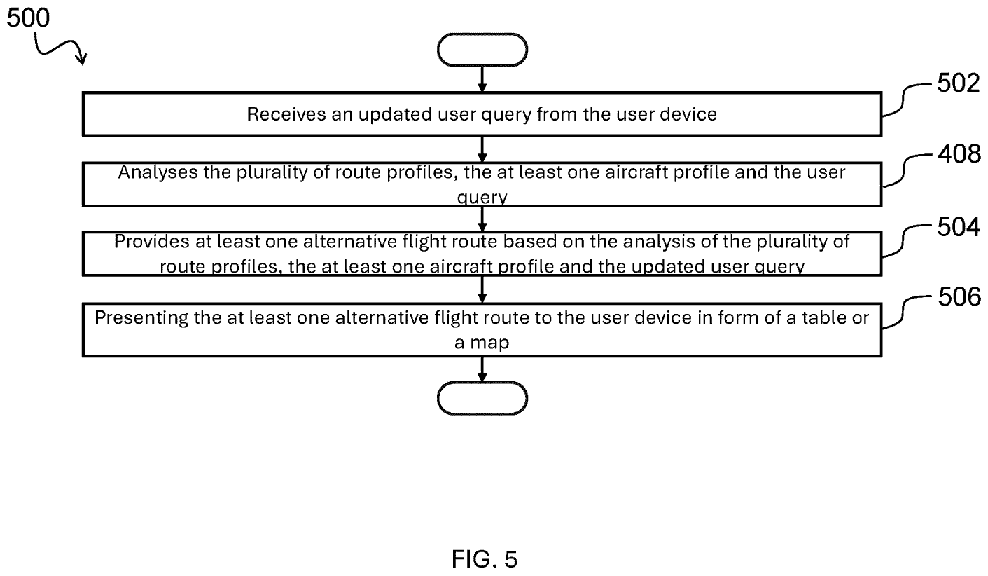

FIG. 5 illustrates another exemplary method 500 according to one embodiment of the invention for use with the plurality of circuits such as plurality of circuits 100 and the plurality of routes. Various embodiments of plurality of circuits 100 and plurality of routes are described herein including in relation to FIG. 1 through FIG. 4. In particular, FIG. 5 shows method 500 that is executable by a controller, such as circuitry or at least one hardware processor, for the operation, or improvement in the operation, of a plurality of aircraft.

At 502, the at least one processor provides an option to the user device 200 to update the user query. For example, the at least one processor provides processor-executable instructions/data which, when executed, in response to which the at least one processor receives an updated user query from the user device 200, wherein the updated user query comprises change in at least one of the plurality of user transportation parameters such as at least one of the first location, the second location, the departure time, the arrival time, the cost, the number of passengers or such parameter as may be obvious to a person skilled in the art.

At 408, the at least one processor analyses the plurality of route profiles, the at least one aircraft profile and the user query as mentioned in method 400.

At 504, the at least one processor provides the at least one alternative flight route based on the analysis of the plurality of route profiles, the at least one aircraft profile and the updated user query.

At 506, the at least one processor presents the at least one alternative flight route to the user device 200 in form of a table or a map any such form as may be obvious to a person skilled in the art

For clarity, various embodiments are included in this description. Each is a numbered example.
Example 1: A method of operation in a system including at least one processor, and a user device in communication with the at least one processor. The method comprises constructing, by the at least one processor, a plurality of route profiles for a plurality of routes amongst a plurality of aerodromes, wherein the plurality of aerodromes comprises a plurality of departure locations and a plurality of arrival locations; receiving, at the at least one processor, from at least one operator, at least one aircraft profile comprising a hub aerodrome and an operational envelope for the at least one aircraft; receiving, at the at least one processor from the user device, a user query comprising a plurality of user transportation parameters; analysing, by the at least one processor, the plurality of route profiles, the at least one aircraft profile and the user query; and providing, by the at least one processor to the user device, the one or more recommended flight routes based on analysis of the plurality of route profiles, the at least one aircraft profile and the user query.
Example 2: The method of claim 1 further comprising receiving, by the at least one processor, a change in the plurality of user transportation parameters; and providing, by the at least one processor to the user device, at least one alternative flight route based on the change in the plurality of user transportation parameters
Example 3: The method of claim 1 further comprising checking if flights corresponding to the one or more recommended flight routes are temporally compliant with respect to at least one of duty cycle, visual flight rules, and operator on-time performance.
Example 4: The method of claim 1 further comprising providing, processor-executable instructions characterizing the one or more recommended flight routes, which when executed by at least one processor presents the one or more recommended flight routes to the user device in form of a table or a map.
Example 5: The method of claim 1 further comprising providing processor-executable instructions, which when executed by at the least one processor, constructs a plurality of route profiles for the plurality of routes amongst the plurality of aerodromes for the at least one aircraft profile comprising the hub aerodrome, wherein the plurality of route profiles is selected from a hub and spoke model and a complete graph.
Example 6: The method of claim 1, wherein the plurality of user transportation parameters comprises at least one of time, a first location, a second location, a departure time, an arrival time, cost, number of passengers.
Example 7: The method of claim 1, wherein a respective route profile in the plurality of route profile comprises at least one of altitude, distance, elevation, and flight level.
Example 8: The method of claim 1, wherein the at least one aircraft profile comprises at least one of climb rate, decent rate, cruise speed, operational envelope, flight rules and fuel capacity.
Example 9: The method of claim 1, wherein plurality of user transportation parameters includes time inferred from a location associated with the user device.
Example 10: A system comprising a user device, wherein the user device is processor-based; at least one processor communicatively coupled to the user device; and at least one non-transitory processor-readable storage device communicatively coupled to the at least one processor and which stores processor-executable instructions which, when executed by the at least one processor, cause the at least one processor to: receive a plurality of route profiles for a plurality of routes amongst a plurality of aerodromes, wherein the plurality of aerodromes includes a plurality of departure locations and a plurality of arrival locations; receive at least one aircraft profile from at least one operator comprising a hub aerodrome and an operational envelope for the at least one aircraft; receive a user query from the user device, wherein the user query comprises a plurality of user transportation parameters; analyse the plurality of route profiles, the at least one aircraft profile and the user query; and provide, to the user device, the one or more recommended flight routes based on analysis of the plurality of route profiles, the at least one aircraft profile and the user query.
Example 11: The system of claim 10, wherein when executed, the processor-executable instructions further cause the at least one processor to receive a change in the plurality of user transportation parameters; and provide to the user device, at least one alternative flight route based on the change in the plurality of user transportation parameters.
Example 12: The system of claim 10, wherein when executed, the processor-executable instructions further cause the at least one processor to check if flights corresponding to the one or more recommended flight routes are temporally compliant with respect to at least one of duty cycle, visual flight rules, and operator on-time performance.
Example 13: The system of claim 10, wherein when executed, the processor-executable instructions further cause the at least one processor to present the one or more recommended flight routes to the user device in form of a table or a map.
Example 14: The system of claim 10, wherein when executed, the processor-executable instructions further cause the at least one processor to construct a plurality of route profiles for the plurality of routes amongst the plurality of aerodromes for the at least one aircraft profile comprising the hub aerodrome, wherein the plurality of route profiles is selected from a hub and spoke model and a complete graph.

While the disclosure has been described in connection with specific embodiments, it is to be understood that the disclosure is not limited to these embodiments and that alterations, modifications, and variations of these embodiments may be carried out by the skilled person without departing from the scope of the disclosure. It is furthermore contemplated that any part of any aspect or embodiment discussed in this specification can be implemented or combined with any part of any other aspect or embodiment discussed in this specification.

1. A method of operation in a system including at least one processor, and a user device in communication with the at least one processor, the method comprising:
constructing, by the at least one processor, a plurality of route profiles for a plurality of routes amongst a plurality of aerodromes, wherein the plurality of aerodromes comprises a plurality of departure locations, and a plurality of arrival locations;
receiving, at the at least one processor, from at least one operator, at least one aircraft profile comprising a hub aerodrome and an operational envelope for the at least one aircraft;
receiving, at the at least one processor from the user device, a user query comprising a plurality of user transportation parameters;
analyzing, by the at least one processor, the plurality of route profiles, the at least one aircraft profile and the user query; and
providing, by the at least one processor to the user device, the one or more recommended flight routes based on analysis of the plurality of route profiles, the at least one aircraft profile and the user query.

2. The method of claim 1 further comprising:
receiving, by the at least one processor, a change in the plurality of user transportation parameters; and
providing, by the at least one processor to the user device, at least one alternative flight route based on the change in the plurality of user transportation parameters.

3. The method of claim 1 further comprising checking if flights corresponding to the one or more recommended flight routes are temporally compliant with respect to at least one of duty cycle, visual flight rules, and operator on-time performance.

4. The method of claim 1 further comprising providing, processor-executable instructions characterizing the one or more recommended flight routes, which when executed by at least one processor presents the one or more recommended flight routes to the user device in form of a table or a map.

5. The method of claim 1 further comprising constructing a plurality of route profiles for the plurality of routes amongst the plurality of aerodromes for the at least one aircraft profile comprising the hub aerodrome, wherein the plurality of route profiles is selected from a hub and spoke graph and a complete graph.

6. The method of claim 1, wherein the plurality of user transportation parameters comprises at least one of time, a first location, a second location, a departure time, an arrival time, cost, number of passengers.

7. The method of claim 1, wherein a respective route profile in the plurality of route profile comprises at least one of altitude, distance, elevation, and flight level.

8. The method of claim 1, wherein the at least one aircraft profile comprises at least one of climb rate, decent rate, cruise speed, operational envelope, flight rules and fuel capacity.

9. The method of claim 1 wherein the plurality of user transportation parameters includes time inferred from a location associated with the user device.

10. A system comprising:
a user device, wherein the user device is processor-based;
at least one processor communicatively coupled to the user device; and
at least one non-transitory processor-readable storage device communicatively coupled to the at least one processor and which stores processor-executable instructions which, when executed by the at least one processor, cause the at least one processor to:
receive a plurality of route profiles for a plurality of routes amongst a plurality of aerodromes, wherein the plurality of aerodromes includes a plurality of departure locations and a plurality of arrival locations;
receive at least one aircraft profile from at least one operator comprising a hub aerodrome and an operational envelope for the at least one aircraft;
receive a user query from the user device, wherein the user query comprises a plurality of user transportation parameters;
analyze the plurality of route profiles, the at least one aircraft profile and the user query; and
provide, to the user device, the one or more recommended flight routes based on analysis of the plurality of route profiles, the at least one aircraft profile and the user query.

11. The system of claim 10, wherein when executed, the processor-executable instructions further cause the at least one processor to
receive a change in the plurality of user transportation parameters; and
provide, to the user device, at least one alternative flight route based on the change in the plurality of user transportation parameters.

12. The system of claim 10, wherein when executed, the processor-executable instructions further cause the at least one processor to check if flights corresponding to the one or more recommended flight routes are temporally compliant with respect to at least one of duty cycle, visual flight rules, and operator on-time performance.

13. The system of claim 10, wherein when executed, the processor-executable instructions further cause the at least one processor to present the one or more recommended flight routes to the user device in form of a table or a map.

14. The system of claim 10, wherein when executed, the processor-executable instructions further cause the at least one processor to construct a plurality of route profiles for the plurality of routes amongst the plurality of aerodromes for the at least one aircraft profile comprising the hub aerodrome, wherein the plurality of route profiles is selected from a hub and spoke graph and a complete graph.
